(19) United States
(12) Patent Application Publication
(10) Pub. No.: US 2022/0261935 A1
(43) Pub. Date: Aug. 18, 2022

(54) Method for Connecting, Communicating, Collaborating and Distributing Digital Energy Within Independent Devices, Applications and Interfaces Through a Decentralized Digital Community Architecture

(71) Applicant: Jonathan William Hoeflinger, Frisco, TX (US)

(72) Inventor: Jonathan William Hoeflinger, Frisco, TX (US)

(21) Appl. No.: 17/669,579

(22) Filed: Feb. 11, 2022

Related U.S. Application Data
(60) Provisional application No. 63/148,388, filed on Feb. 11, 2021.

(51) Int. Cl. G06Q 50/18; G06Q 50/00

(52) U.S. Cl. CPC G06Q 50/184; G06Q 50/01

(57) ABSTRACT

Today's digital community architecture, modeled after DC platforms, deprives online users of the experiential flow of their digital community experience. Current DC platforms are premised on the unidirectional flow of digital energy to a select few entities, thereby diminishing the strength of others' digital assets and community experience. This minimizes the collective value of independent communities or organizations. The present invention is modeled on an AC, or alternative community platform, which facilitates a more efficient method for building, maintaining, scaling, and distributing digital communities and their respective digital energies. The decentralized AC model gives users control of data, thereby creating unlimited channels for resource distribution. Thus, these decentralized AC communities promote user control and ownership of their respective digital energies. Such a design offers a more efficient use of digital energy that ensures and preserves the production value of physical communities operating in digital spaces.

### CROSS-REFERENCE TO RELATED APPLICATIONS

The application claims the benefit of U.S. Provisional Application No. 63/148,388 filed on Feb. 11, 2021.

### TECHNICAL FIELD

The present invention relates generally to a method for connecting, communicating, collaborating, and distributing digital energy within independent devices, applications, and interfaces through a decentralized digital community architecture.

### BACKGROUND

In the second half of the 20th Century, Ervin Laszlo established the field of systems philosophy. Laszlo's aim was to use a systems perspective to model the nature of reality. Underlying the basic tenet of this thought is the universe's operation as a network or community of systems. If we can understand how to translate proven principles into common practice, then nature can provide a prepossessing blueprint for sustainable innovation. Translating these principles to the modern digital world reveals several problems existing in our digital platforms that negatively impact our physical world. A significant number of these problems experienced today are a product of the modern digital business model, which has been in practice since the inception of the internet.

Understanding nature's blueprint continues to provide important discoveries in practices like translating applications to energy. Our understanding of the First Law of Thermodynamics states, “nothing is created, nor destroyed, but moves from one form to another.” When applied to the current digital world, we experience numerous types of digital energy moving both systematically and stochastically from one form to another.

Upon the advent of electricity, Edison patented a direct current model. This model provided a current that flowed continually in a single direction, much like those found in a battery, fuel cell, or light bulb. This direct current model was the standard in the United States at the time, but it remained plagued by one major problem. Direct current does not convert easily to and from lower and higher voltage levels. As discussed further below, modern big tech companies suffer a similar shortcoming in a parallel structure with their Direct Community platforms, which are primarily engineered to ensure that Content (e.g., digital energy) flow directly back into their 3rd-party platforms and 3rd-party application providers.

Shortly thereafter, Tesla developed an electrical alternating current as the solution to the above mentioned direct current model's fluctuating limitations. An alternating current reverses a certain number of times per second, and by using a transformer it can convert energy to various voltage levels with relative ease. The present invention discussed further below maintains a similar versatility and flexibility with its Alternative Community utilities, which permit expansion of the flow of Content in unlimited directions between 1st-party owners to 2nd-party consumers, thus bypassing the need for a 3rd-party platform control.

Since the mid-1990s, there has strictly been a unidirectional flow of digital energy on what we call 3rd-party Direct Community (“DC”) platforms and 3rd-party application providers. Big technology companies are designed to consume digital energy in this manner and over time, this framework poses numerous serious limitations. Digital communities are clearly struggling to power their various organizations on today's 3rd-party platforms and 3rd-party application providers in a manner akin to renting space. When we build a digital community on a foundation we do not own, we relinquish control over our community experience, communications, content, commodities, currencies, and use of data to 3rd-party platforms and 3rd-party application providers who subsequently wield the power to aggregate and leverage this information against our own organizations.

The issues we see in the digital landscape today derived from the current DC platform prove that technology has not been able to engineer or adapt to these types of inevitabilities of scale. Meaning, the communities that build these interactive social systems of interaction lose their sovereignty and the freedom of cross-distribution required after they contribute to today's technology. The system(s) they align with (e.g., Facebook) becomes the source of interaction; and eventually the source of the resource—leveraging out the client (who brought the community) to the benefit of the DC platform. The client loses control of their own process and flow of their community experience as it gradually erodes.

Big tech companies like Facebook, Amazon, Apple, Netflix, Google, Salesforce, and Slack (FAANGS) have successfully developed a DC platform system like that depicted in FIG. 1. Their value-chain runs in one direction by leveraging the digital energy of clients and their respective communities inside the DC platform. This model came out of an industrial era paradigm where phrases like “corner the market” and “monopolistic advantage” and “proprietary information” were important business practices. As such, the early adoption of the DC platform has borrowed and built on these methods, and then aggregated and leveraged the community by which it operates to ensure a powerful monopoly. There are hidden constraints within this digital social community framework, such as tight manipulation of the rules of entanglement with algorithms that serve their platform and build their business.

DC platforms aggregate all forms of Content and leverage the digital energy potential of its users to strengthen its own digital asset to the detriment of others. Organizations give up their sovereignty and minimize their digital energy capacity when they build upon and interact within a DC platform. The FAANGS have successfully implemented the DC platform model; and as a result, their stock is up. Meanwhile, the rest of the market is not seeing the same type of financial lift for their companies when operating their businesses through a DC platform. This is an ongoing problem.

The First Law of Thermodynamics states that, “nothing is created nor destroyed, it simply moves from one form to another.” As such, the energy value of a physical organization with a value of 100 ev loses its energy potential at scale when it converts its physical organization into a digital community experience.

This process expands the more a digital community utilizes the 3rd-party DC platform and 3rd-party application providers. Any transient gains by that digital community are eventually absorbed by the 3rd-party DC platform and 3rd-party application provider through the leveraging of the Content, wherein Content is any digital input generated by the DC platform and/or its usership into the DC platform.

Organizations and communities comprising large populations are required to onboard their collective communities in one form or another onto the 3rd-party DC platform to use the desired service. As a result, the collective digital energy of an organization or community necessarily flows unidirectionally, which is the primary attribute of the DC platform and mirrors the use of direct current with electricity.

Additionally, many communities and organizations have adopted a practice common to and promoted by the FAANGS and similar DC models using a “Connect with Us” feature that minimizes the collective energy value of an independent community or organization even when operating outside the context of a DC platform. As a community's users onboard into a digital application by way of a 3rd-party DC platform and 3rd-party application provider, the digital energy continues to flow in one direction, toward the corresponding DC platform. This industry-wide practice of implementing “3rd-party registration and login” features onto an organization's digital application continues to refract users and their collective digital energy away from the context of the community's primary digital experience and back into the silos of the 3rd-party DC platform 3rd-party application providers. Consider the power a community organization, and its users, might produce should it break from the digital energy loss caused by the DC platform architecture.

DC platforms are designed to harness their own digital energy and their service value is minimized when utilized outside the context of their own platform. As a 3rd-party platform and 3rd-party application provider, individuals may onboard at no cost and utilize that 3rd-party platform service, thereby rendering the organization a product of mass activity. In other cases, organizations do charge fees for their service, but the paid-for features are accessible only through the context of the 3rd-party platform and 3rd-party application provider. Such paid-for features provided by 3rd-party DC platforms and 3rd-party application providers often have excessive features catering to the various needs of its community segments, which in turn reads to most users as clutter, technological debt, and poor structure design.

There are hidden constraints within these digital social communities that are also visibly present in a physical community. Our ability to connect, communicate, and collaborate in a physical city is based upon a) social networks, b) resource distribution infrastructure, c) record-keeping, and d) rules of law. Social networks are comprised of physical interactions amongst families, churches, congregations, school classrooms, work associations, sporting teams, musical ensembles, government groups, and so on. Infrastructure refers to the physical elements necessary to support the interactions between the social networks such as roads, pipelines, wires, vehicles, public parks, various types of buildings, and so on. Record-keeping refers to the data collected, stored and shared with stakeholders to make more informed decisions. Rules of law refers to the laws and regulations that govern a community to ensure life, liberty, and justice of its citizens.

The most important attribute of a physical city is land ownership. The owner has the incentive to improve his space and to create and to maintain its upkeep. There must be vertical ownership before there can be horizontal distribution. From this place of ownership, products, services, and other resources can be created to supply the needs of the community and provide value back to the source owner—who continues to maintain the land. The owner distributes these resources from the land to other landowners or to shared spaces where the product and services can be consumed. However, there must also be channels for horizontal distribution to reinforce vertical ownership. In the vertical-horizontal exchange, there are data points shared by both parties for their part in the transaction. Simultaneously, the rules of law must be obeyed during these transactions; these are spelled out in contract between the stakeholders (law of the people) and underscored by the governments established to maintain order (law of the land).

Simultaneously, our ability to connect, communicate, and collaborate in a digital city is based upon a) social networks, b) resource distribution infrastructure, c) record-keeping, and d) rules of law. Of these digital communities there are two types that produce eV in the form of Content. The first, Direct Community (DC or DC!), is the current practice of technology giants in the early part of the 21st Century, discussed supra. The second type of digital community is the Alternate Community (AC or AC!), which this invention proposes as the more efficient method for building, maintaining, scaling, and distributing digital communities and their digital energies for the future modern digital societies.

Currently, our digital communities do not properly align with our physical communities. All human activity, whether it be physical or digital, requires the interaction between people (social networks) and the continual exchange of resources, such as, information, product, services, money, communication, for example, between people (resource distribution infrastructure or eV value); and properly maintained in some form of database (record-keeping) underscored by a legal framework by which all stakeholders have the freedom to earn and defend their property (rules of law). In a modern world, a city can thrive when the features of a physical community are properly aligned with the features of a digital community.

In the digital sense, the decentralized digital community architecture of the present invention provides vertical ownership to the client and horizontal distribution to and from any other connected client. The client owner is the source, the channel, and the recipient of goods and services, and the client can negotiate smart contracts or monetize on its behalf with stakeholders bypassing the need for any 3rd-party involvement. Without clear boundaries of ownership, there is disorder as to how people move in the city, which in turn promulgates disorder with increased interactions.

Unlike DC platforms, a decentralized digital community architecture, on the other hand, gives the user (the source of the data) ownership and control of the data, store, and community in the context of the user. It provides unlimited channels for resource distribution through an algorithm owned by the client; ability to align with the rules of law.

In physical communities, growing cities struggle with traffic. Too many people on roads designed for smaller populations create traffic jams that slowdown the cities' ability to move around and function. At peak points of such movement, three lanes of traffic reduced to two lanes of traffic creates refraction points that push back traffic further back and delay the delivery of resources to the area of greatest need. For cities to improve, they must build infrastructure to properly manage the load and demands of a growing city.

Modern bridges are designed to manage vertical motion, horizontal sway, and amplified resonance caused by the combination of the motion and sway. Many bridges have failed because of a city's inability to engineer for the amplified resonance. For example, when people walking across a bridge feel the sway, they adjust their steps side-to-side to align with the sway—but this further amplifies the sway. As more people walk across the bridge at the same time, the bridge cannot manage the movement, ultimately leading to the structural collapse of the bridge. In digital communities, it is imperative that technology is engineered to account for similar vertical motion, horizontal sway, and the amplified resonance (and oscillations) that occur when digital communities scale.

These same problems exist with digital cities, which lack contextual ownership, digital channels for communication, content management, commodity controls, currency regulations, cross-coordination of data, and distribution methods to support the needs of their community at scale. The decentralized digital community architecture, discussed infra, removes the known refraction points that inhibit efficient use of digital communities, which produce digital or media content and analytic data related thereto in order to better ensure and preserve social interactions, resource distribution, data source, and the rules of engagement. To use a plant metaphor, it gives communities the ability to grow vertically where they are planted and branch out horizontally where their seed flows. In such a framework, users own the ground in which they live; users have the freedom to distribute their own goods, services, and content to the receiving community. The proposed invention further provides a method to plant, grow, and scale in a manner, style, and rate on terms as determined and controlled by the user, instead of by third party entities.

The present invention is designed to operate as an AC utility, where digital energy flows in multiple directions throughout an interconnected community of platforms. This AC utility service is an efficient and optimal product of the new virtual era requiring a technological system that allows communities to work as a cohesive unit, while offering autonomy to a community's local parts when they want to work individually.

The present invention further provides a decentralized architecture and various digital software utilities that serve as a cohesive unit to support various forms of digital energy. These digital software utilities include everything from networks to communications, campaigns, tools, statistics, finances, goods, services, marketplaces, and more. The ability to contextualize this digital energy and to transfer it from one platform to another is why digital communities have the capacity to scale and maintain sovereignty over the content they produce, the products they distribute, the data they store, the community they serve, and the contexts in which they deliver unique digital experiences.

Such digital software utilities permit participants to “build their own” individual digital community platform. The digital utility services implement and maintain the decentralized digital infrastructure tailored to support a community platform by maintaining a digital supply line functionality between various iterations of communities.

This proposed decentralized architecture grants organizations and/or communities revenue opportunities that until now were primarily enjoyed by big tech companies. The decentralized architecture further described below drives digital energy to areas to stimulate commerce, sustain a variety of causes, and defend the digital sovereignty of the physical communities they serve. A primary benefit of the proposed invention is a method that produces more efficient use of digital energy that ensures and preserves the production value of our physical communities operating in a digital space.

Regarding the application of a decentralized digital community architecture, the proposed invention integrated into a Mobile Application is an example of how we engineered for Vertical Ownership, and the invention shown in a Desktop Software is an example of how we engineered for Horizontal Distribution. The “Fandom” feature shown in both a Mobile Application and a Desktop Software is an example of how we engineered for Amplified Resonance—ensuring no points of refraction occur or displacement of community as interactions scale in multiple directions.

In 2020, we experienced a paradigm shift. Organizations of all shapes and sizes, who had relied primarily on physical community engagement in churches, schools, and arenas, suddenly found themselves without a place to gather. Many flocked to existing DC platforms and quickly found their own community experience suffered at the hands of the same DC platforms. Digital communities survived, but they did not thrive. Those who benefited from providing a digital life raft for community engagement were the FAANGS via utilization of DC platforms. Organizations are waking up to the fact that DC platforms steal digital energy away from their digital community experience; including, having the power to block, censor, or eliminate at their discretion a community organization with an algorithm change.

There are growing trends by countries, companies, and other forms of community who have entered into a tug-of-war with the technology giants to understand how their digital sovereignty is being impacted by DC platforms. We swallowed the belief that building the FAANGS community was somehow building our own community, unaware of the prospects of an AC utility service with which to compare and contrast.

Presented with several attractive amenities, DC platforms appear efficient way to manage our businesses, organizations, and community groups. DC platforms appear, in that it has aggregated so many resources, consumed so many communities and streamlined so many features that it currently has a certain advantage over an AC utility. Community organizations are finding ways to utilize the power available through DC platforms, but it is a “work-a-round” at best. Mixing and matching multiple DC platforms has proven to add complexity, technological debt and other inefficiencies to the management of digital community assets (e.g., Digital Application).

Imagine utilizing a dozen backend DC platforms to scale a single Digital Application—where you must login to a dozen different DC platform applications. If you were to scale this method with your existing community, you would in turn be forced to ask your expanding community to utilize the same administrative features to login across the same dozen applications. Your audience is diffracted across a dozen different platforms, none of which are designed to power your business, but rather to empower their own DC platform. This is just not practical, and it is a primary reason why digital applications powered by DC platforms do not scale. As a result, digital applications powered by DC platforms tend to collapse under the weight of their own growth and limp along because it's all they know to do.

Meanwhile, today's standard DC platforms continue to absorb a community or organization's digital energy value. They are successfully designed to own their own platform and convinced the rest of the world that renting space from them is somehow akin to owning it. One look at the stock market would confirm this reality.

In a physical community, there is a place for renters and owners. Both have their advantages and disadvantages. But it is certainly a wide-held understanding that it is better to own than to rent. In a physical environment, many young people, when first moving out on their own, rent space. As they mature over time, living in close quarters with other people, sharing walls, experiencing unwanted noises and nuisances of all kinds, and with new additions to the family unit create a need for more space. Thus, there is a desire for home ownership and autonomous space.

This same physical community phenomenon exists in our digital communities. As a community organization in any industry matures over time, it is clear to most organizations that they are not able to rent space to service their expanding needs at scale. The more a digital community grows, the more mastery of its rules, roles and resources plays a part in its ability to scale.

As the market for a digital Alternate Community grows, its ability to implement similar features, powered by decentralized digital utility services, provides a stronger foundation for the future of sustainable digital communities in every context around the world.

Many modifications and other embodiments of the invention discussed above will come to mind to one skilled in the art to which this invention pertains having the benefit of the teachings in the discussed descriptions. Although specific terms may be employed herein, they are used in a generic and descriptive sense and not for purposes of limitation. Accordingly, the present invention is not limited to the specific embodiments illustrated herein.

### BRIEF DESCRIPTION OF THE DRAWINGS

FIG. 1 is a schematic of the current Direct Community platform wherein big tech companies benefit from the amalgamation of communities' digital energy;

FIG. 2 is a representation of the proposed Alternate Community matrix wherein digital energy flows multi-directionally to the benefit of all discrete communities;

FIG. 3 is a chart showing interaction between social communities;

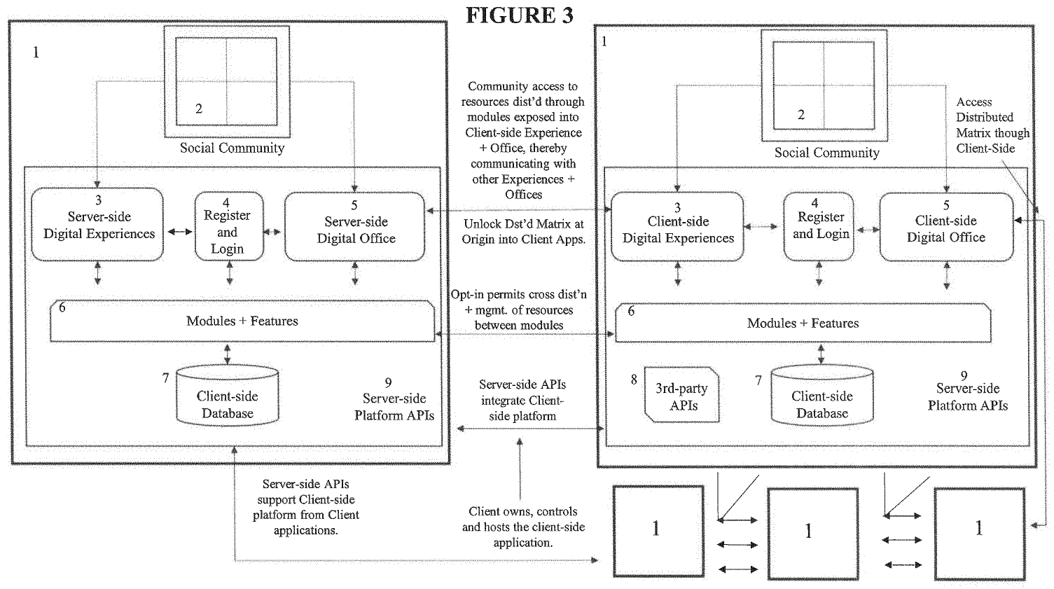

FIG. 4 is an overview of the present invention;

FIG. 5 is an additional overview of the present invention; and

FIG. 6 is a schematic of the Alternate Community energy grid.

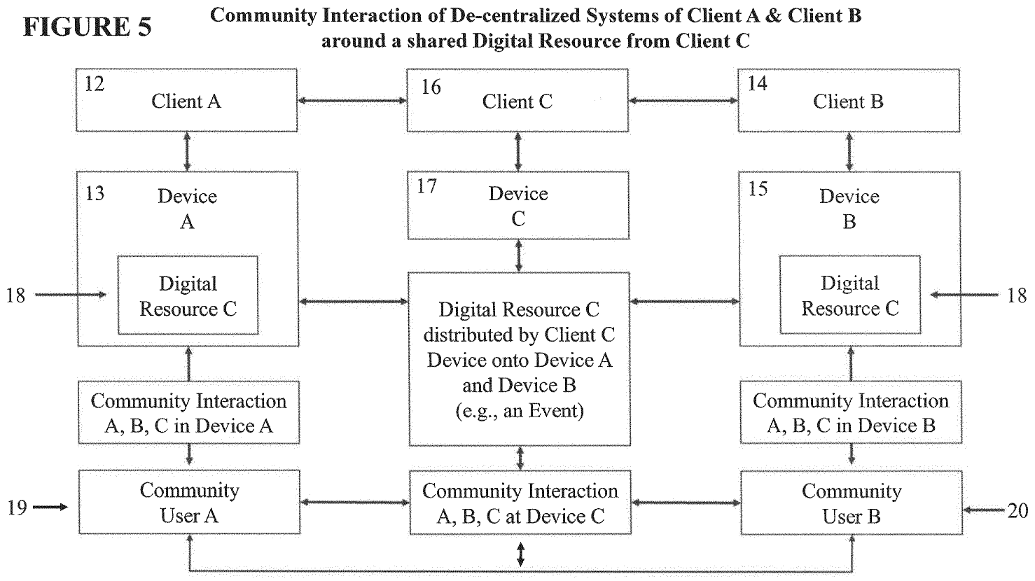

Referring to FIG. 5, depicts a method for connecting, communicating, collaborating and distributing digital resources within and outside of independent devices, applications and interfaces through a decentralized digital community architecture. Whereas communication is a form of digital resource; whereas an event is a form of digital resource; whereas a user is a form of digital resource; whereas a client owns its own device and serves its own community, whereas community interaction includes all forms of user-types.

Whereas user A in one device A communicates around event C that is shared within device A with another user B that communicates around the same event C that is shared within its device B that is owned by user C who created the event C from within its device C. All users/clients, A, B, C illustrated in FIG. 5 can communicate from their respective devices around a shared digital resource without having to be displaced to the adjacent device, application or interface to interact. Upon connection, User A and User B may continue to interact from separate devices.

### SUMMARY OF INVENTION

A decentralized digital community architecture is a free-flowing interconnected digital application interface designed to ensure connection, collaboration, communication, distribution, source of resource, and sovereignty of each digital resource across devices. It removes the digital refraction points that inhibit more efficient and effective interactive connection, distribution, and collaboration between audience-to-audience, audience-to-network, network-to-audience, network-to-network, portal-to-audience-audience, portal-to-audience-network, portal-to-network-audience, portal-to-network-network, audience-audience-to-portal, audience-network-to-portal, network-audience-to-portal, network-network-to-portal, and portal-to-portal digital applications interfaces as further described below. The present invention allows users to manage, expand, and engage networks, automate marketing, funding, or informational campaigns, apply data analytics, measure social impact, generate revenues, and streamline media distributions to a target audience using at least the internet.

The decentralized digital community architecture provides a multi-channel, collaborative connection for distribution of any digital resource between many nodes of a digital application interface. Each node represents a user type. For example, types of user nodes may consist of general users, influencers, philanthropic, marketplace, media, and government user types with sub-user types that represent every type of organization and their respective employees. Audiences are made up of various names as they relate to a network user. For example, an audience to a government is a citizen, to a politician is a voter, to a business is a customer, to a nonprofit is a donor/beneficiary, to a celebrity is a fan, and so on. You may further have users that are customers, donors, voters, volunteers, event goers, subscribers, and general users that interact with a brand, or even key influencers, retailers, franchisers, CPGs, NGOs, 501(c) nonprofits, media-marketing agencies, or governments.

Each user node has unlimited channels of connection with other user nodes. Each user node has its own unique digital position, is the source of digital resources, the channel for cross-channel digital distribution, a portal of digital collaboration around the resource, and a central access point to add more nodes. The present invention streamlines media distribution and community engagement through a distributed node platform. For example, a user can embed a broadcast, upload videos, messages, create a post, submit stories, provide comments, and the like through various forms of digital inputs or media content (collectively “Digital Content”). Digital Content and its digital resources may further include, but are not limited to, communities, fandoms, expos, campaigns, currency, data, products, services, applications, text, communications, events, the internet of things, fundraisers, and the like, all connected to the decentralized digital community architecture. The user can then gauge the social impact of such Digital Content with feedback on who is viewing such content, the demographics of the content viewers, revenue generated from such content, and the overall social impact such content may have within the social media platform.

This analytic feedback may be provided to a user in the form of a digital dashboard. This analytic feedback method of collecting, managing, and providing real-time or near real-time relevant information allows a user to collect information directly related to the Digital Content such that a user can adjust the Digital Content for more effective exposure to the distributed network. This information allows users to quantify opinions on published Digital Content social media sites to gain useful insights into current sentiment within the distributed network and trends relating to their products or services, brands, and/or technologies. Collecting and presenting this information can help users in a variety of ways such as target advertising revenues and expenditures, marketing, sales, customer service, brand management, product development, and investor relations. While standard social networking sites are currently trying to leverage and monetize their own user profiles to target advertising based on their users' behavior and declared interests, the present invention puts the power of social media into the hands of the user and permits the user to control its own Digital Content and the analytics which flow therefrom.

The present invention fosters a design layout for the interactions between data layers, infrastructure layers, and community layers that make up the primary elements of a digital application interface. The present invention further allows for the organization of the entire community structure, in all its roles and forms, to coexist. For example, including, but not limited to, citizens, clubhouse, neighborhoods, cities, and metroplexes.

The present invention even further allows for the interweaving of digital resource distribution across unlimited channels between one or many nodes. The invention allows for modules to create, store, collaborate, and distribute digital resources. The invention allows for the decentralized digital community architecture to be delivered as a distributed service, thereby ensuring ownership to the respective node for distribution of its resources across channels.

A higher-level description of the present invention would be a distributed matrix that organizes user social channels and creates a digital hub for resource distribution using at least the internet and/or intranet. A user's audience becomes one central network to deliver messaging quickly and efficiently. After organizing a user's social channels, the present invention helps amplify resource distribution by supplying the distributed network with those campaigns targeting that user's unique audience.

While the above description constitutes the preferred embodiment of the present invention, it will be appreciated that the invention is susceptible to modification, variation, and change without departing from the proper scope and fair meaning of the accompanying claims.

### DETAILED DESCRIPTION

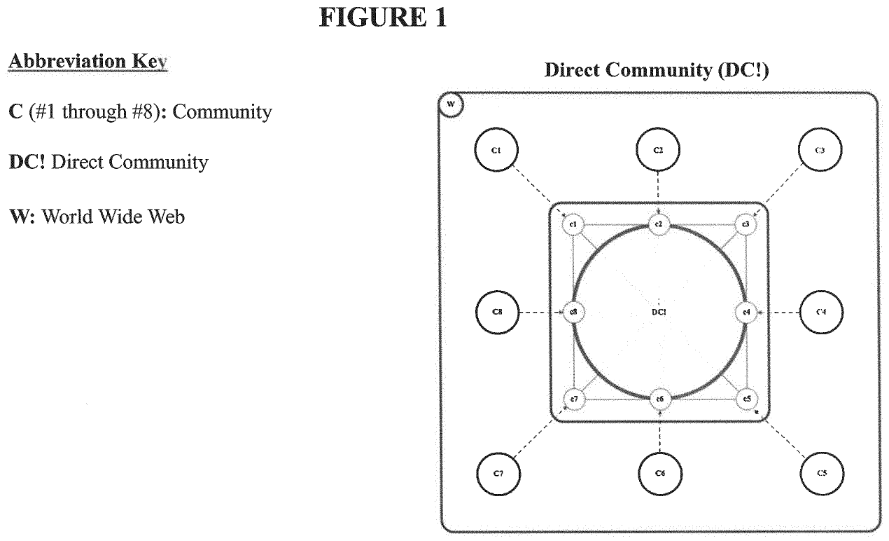

Referring to FIG. 1, the Direct Community (DC) is platform-based, wherein digital energy flows in one direction and the subsequent digital energy value is isolated inside one community context, often THE big tech digital infrastructure. The direct community platform monopolizes, isolates, aggregates, and leverages digital energy and is built to rent digital space rentals rather than permit ownership of one's own digital space throughout various networks, including at least the internet. The direct community platform further regulates the algorithm controlling the flow of digital energy and runs as a second-party or third-party service, thereby stealing communities' digital energy.

When an organization powers its community using a DC platform, it minimizes Energy Value (eV) in a digital environment. Referring again to FIG. 1, eight (8) physical organizations, as indicated by C1 through C8, start from a physical environment with a starting value of 100 ev. Each physical organization's creation of a digital community experience inside a 3rd-party DC platform results in the diminution of an organization's digital energy value. Thus, FIG. 1 shows that 50 eV is taken from each of the eight (8) different digital communities, thereby converting it into digital energy that is consumed and stored by the 3rd-party DC platform and/or 3rd-party application provider, thus increasing this 3rd-party's DC platform digital energy to 400 eV.

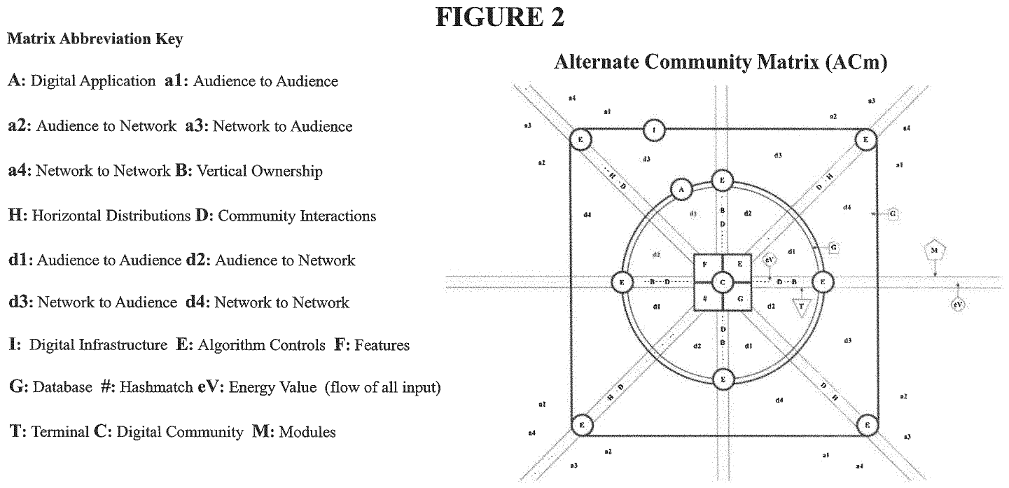

Referring to FIG. 2., elements a1 thru a4 represent the physical community environment by which interactions take place and then impact the digital community interactions, represented by d1 through d4, which mimic the physical experience and in turn further drive interactions in the physical and digital environments, simultaneously. This is like the sway and vibrations in a bridge that must be accommodated to avoid disastrous consequences to the occupants using the bridge. To maintain a steady state between the physical and digital environments, there must be equivalent physical and digital roles present to support the weight of a community that connects, communicates, collaborates, and creates content (e.g., digital energy) in all its forms at scale.

The present invention's decentralized digital community architecture is further designed to build decentralized digital social communities using at least the internet; to match digital applications with physical infrastructure in the context of the owner; to ensure ownership of the digital application, product and service; to authenticate cross-distribution of digital resources; to ensure cross-interaction of social communities in all its contexts; to provide algorithm controls of exchanges of data, money, community, and other digital resources; to provide modules that ensure connection, communication, and collaboration across all points of interaction; and to provide a data ledger that ensures the source and authentication of distributed data related to any exchange between users and interaction around any digital resource.

In the digital sense, the decentralized digital community architecture of the present invention provides vertical ownership to the client and horizontal distribution to and from any other connected client using at least the internet. The client-owner serves as the source, channel, and recipient of goods and services, and can directly negotiate smart contracts on its behalf with stakeholders, thereby bypassing the need for 3rd-party oversight or involvement. Optionally, a user can selectively remove, delete or modify from one or more decentralized digital community that user's content as the user's discretion.

The decentralized digital community architecture removes the common refraction points that inhibit efficient use of Digital Content and analytic data related thereto in order to better ensure and preserve social interactions, resource distribution, data source, and established rules of engagement.

The proposed alternate community (“AC”) depicted in FIG. 2 utilities are designed to distribute the energy of its own digital community. The methods supported by this AC model are maximized when used in any digital community context. The services used by the primary community owner are consistent, end-to-end, and maintain the utilities used by the community in every context. The AC utilities negate the need for utility services that do not have a consumer-facing purpose in the context of the digital community asset of the client, city owner, or digital community owner. As a result, any digital community powered by AC utilities maintains the most optimal efficiency for the scaling of a digital asset in their own context and contextualized for use in an adjacent digital community.

AC attributes include, but are not limited to, being utility based wherein Content flows are multi-directional rather than the DC model's unidirectional flow. ACs also distribute the energy value across multi-community contexts, thereby sharing, distributing, and circulating resources using at least the internet. Further, ACs are built to own digital assets, are first-party services (shares digital energy) and are designed such that clients, rather than the platform, control the algorithm. In both DC and AC models the position of the users is the same, but the distribution of digital energy values are completely different.

Referring again to FIG. 2, Digital energy (eV) is created by Content produced inside each Digital Application (A) and then transmitted to a Module (M) (for backend supply of resources) & Terminal (T) (for front-end consumption of resources) where the Content is then converted into the context of the adjacent Community (C1 thru C8) depicted in FIG. 1 for end use or consumption by users and Community Interaction (D) in the adjacent Digital Application (A) of another Digital Community (C1 through C8).

Referring again to FIG. 2, Content (eV) is created from inside a Digital Community (C1 through C8). It is then transmitted through a host of digital Utilities (U) that are internal to the Digital Application (A). However, the same digital Utilities (U) are also connected to an external network of communities (C1 thru C8) inside a Module (M), which serves as a transformer (transmits, converts, distributes, and/or warehouses) Content (eV) inside the Digital Infrastructure (I) of the Digital Application (A). Communities are not limited to those eight shown but can expand without limitation.

Communities (C1 through C8) are able to access Modules (M) from within their own Infrastructure (I), while the Modules (M) as shown in the grid are positioned to show how one or many Digital Applications (A) can source and distribute resources in a shared space without having to leave their digital or physical locations (and retain their ownership as the source, or license distributed resources from adjacent cities) generated in a Digital Application (A) through multi-directional modules shared by micro or macro communities.

(T) represents a Terminal of Digital Application (A) of interactions between the Resource (eV) (sourced and/or distributed) and the Community Interaction (D) that engages around a Resource (eV). The difference is that this interaction takes place externally, while remaining in the context of where the Resource (eV) is distributed.

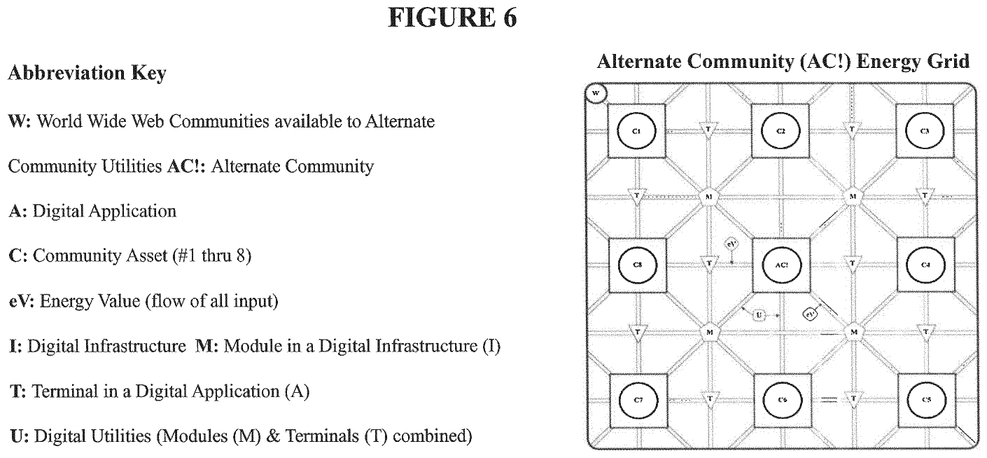

For example, an adjacent Community Asset (C1) administrator can communicate with the audience of another Community Asset (C2) around a shared Content (eV) which is sourced from the originating Digital Application (A), distributed into the context of other Digital Applications (A). See FIG. 2, FIG. 6. All parties remain located in their respective digital context and digital position, while still being able to cross-transmit communication through Terminal (T) around a shared resource/content (eV) that was sourced from the Module (M) of an adjacent Digital Community.

Organizations preserve their sovereignty and maximize their physical and digital energy capacity when they interact in an AC utility architecture. The AC utility shares all forms of content and distributes digital energy to its users to reinforce its own strength as a digital asset.

Referring to FIG. 2, (AC!) means the Alternate Community portal, as depicted in FIG. 6 where digital Community (C1 through C8) can access digital Utilities (U) and integrate its services into their Digital Applications (A). Once the digital Utilities (U) have been integrated into Digital Application (A), then Community (C1 thru C8) is able to manage their entire digital community experience (A & I combined) through their own digital Utilities (U) located in their own Infrastructure (I). Community (C1 thru C8) owns Content (eV) created inside their own Infrastructure and Digital Application (I & A combined). In the context of the present invention, AC! owns, here on its behalf, Utilities (U) outside the context of services within Community (C+I+H) and licenses these Utilities (U) for purposes of connecting resources from one community to an adjacent community using at least the internet.

(U) means digital Utilities made up of various modules that source, store, manage, distribute, contextualize, transmit, and consume Content (eV) in all its forms, including but not limited to: (a) Networks (User Types, User Roles, Registrations, Applications, Nominations, etc.); (b) Communications (Text, Email, Phone, Notification, Alert, etc.); (c) Campaigns (Posts, Initiatives, Articles, Courses, TV, Movies, Documentaries, Events, Blogs, etc.); (d) Statistics (any form of data collected from any interaction shared between users in alternate communities and in context of any digital application connected to an alternate community); (e) Tools (features that are created by the community and shared with other adjacent communities); (f) Finances (monies paid and received from any interaction shared between users anywhere in an alternate community digital environment); (g) Shops (products and services sourced by any user in an alternate community); (h) Modules (occur in the digital architecture foundation, all resources made available to micro communities and/or the collective adjacent cities utilizing the power of AC. Modules contextualize digital energy from node to node in the backend admin and support systems of a city-facing digital application experience (think of this like a digital supply chain); and (i) Terminals (occur in the user-facing experience, an external communication tool that ties together community interactions around a resource to the owner of the shared/sourced Resource of an adjacent City with an external community audience in context of the digital application. Terminals contextualize digital energy from node to node in a user-facing digital application experience (think of this like a digital store-front).

(I) is the Digital Infrastructure that sits underneath a Digital Application (A), where the various Utilities (U) Content (eV) is energy in the form of data, text, audio, video, or images that are transferred from one Community to another for analysis, transaction, communication, presentation, distribution, processing, storage, or hosting in one or many contexts, including all forms of digital networks, communications, campaigns, tools, statistics, finances, products, and services.

Flow (eV), Resources (eV), and Community engagements (D) are multi-directional and have multi-dimensional entanglements as shared exchanges flow back and forth simultaneously across digital spaces within Utility's (U), digital modules (M), and terminals (T) to/from one or more community Digital Applications (A) to/from other community Digital Applications (A). This method is critical to meeting the economic (e.g., layers of supply, demand, and price) requirements of a digital community, both locally and globally (e.g., across long distances).

Referring again to FIG. 2, distribution of digital energy comes in multiple forms and moves in multiple directions inside the context of the client application as it relates to each community and its respective roles. Community forms include, but are not limited to, audience to audience (d1), audience to network (d2), network to audience (d3), and network to network (d4) interactions. The ability for various forms of community to interact in multiple directions (as between d1-d4) in context of the client (and in context of digital energy distributed to/from another context) serves as a form of digital insulation that properly contains the digital energy and focuses its use—ensuring that digital energy values remain homeostatic and maintain efficient use of digital energy within the ACm. When these elements are removed from the alternate digital energy distribution method a digital energy barrier forms in the wrong places, causing irreparable harm to the energy homeostasis. If digital energy is unable to flow in multiple directions inside and outside the context of the asset on the internet, then in many cases it may crash the digital assets because the application cannot contain the digital energy value of the community it serves, or the digital energy value is removed entirely, thereby reducing the potential energy opportunity. Thus, d1-d4 maintains an energetic balance and a steady-state of the digital energy that flows through the ACm.

Referring now to FIGS. 2 and 6, (W) Physical Infrastructure refers to the physical environment in which people interact together. The present invention mirrors a physical environment as it represents a physical location and organization, identifying and translating the “tangible experience” into a digital setting. This physical environment operates in a sphere of individual and corporate activity connected by digital channels through which people interact with each other as they go about their business. As products are sourced, services are rendered, and information is exchanged, these passageways expand and contract to accommodate the various activities and flow of distribution as people, businesses, and networks interact with each other and extend into the public domain.

(A) Digital Applications define the tangible experience in the digital application. Every physical feature that exists in the client-owner's organization and network has a digital application. This sphere of “tangible digital features” encompasses all the touch points between the client-owner's physical network and community they have developed. These digital applications are custom-fit to the needs and touch points identified within the organization, accommodating the cross-distribution of their resources, production, and services as they reach out and interact with people. The present invention is engineered in a spherical environment, where one end point serves as the beginning point connecting in all directions across vertical, horizontal, and diagonal planes. So, that depending upon where you are positioned in the matrix, the client is the center of its world and/or a connector and/or a contributor to the world that is adjacent; and where the source of all interactions is authenticated by the inventions decentralized hash system.

(B) Vertical Ownership refers to a client's ability to stake an ownership claim on a digital space using at least the internet. Operating from a physical location, the client-owner is given the freedom to create, source, cross-source, and distribute products and services from this digital space using at least the internet. The present invention provides the client-owner a Digital Owner Hash, enabling his organization or community to interact privately within this digital private space, and with other networks, communities, and individuals. Along with the decision-making processes involved, the client-owner owns and operates the data layer, the product and service layer, and the community layer using at least the internet.

(eV) Energy Value represents sourced digital resources that ensure the client-owner retains ownership of the products and services he created, sourced, produced, and distributed from his location in the physical environment as it transfers to and is distributed through his digital space to other digital spaces. Through a source hash, the invention identifies the host, source, and controller of the products and services. If the client-owner owns the product or service in his physical location, he owns it in his digital space as well.

Distributed Digital Resources are identified and specified by the client-owner which control the distribution channels, products, pricing, and other specific perimeters determined in negotiated business agreements, which channel through the central distribution hub. The present invention allows the central hub to filter all transactions and interactions through the system of Algorithm Controls (E), Modules (M), Features (F), and a Database (G), designed specifically for the client-owner as collaboration, products and services, and information flow “back and forth” throughout their community and other business networks. The invention allows for each party involved in the creation, distribution, and beneficiary of a digital resource to share a part of a contract hash, which is verified through each participating client owner hash, timestamp, and entered into a decentralized distributed ledger. A digital resource can be represented as anything digitized like campaigns, money, profiles, people, products, services, telemetric data, events, etc.

(H) Horizontal Distributions define and authenticate the physical and digital distribution and cross-distribution of resources. The distribution channels encompass a sphere of unlimited passageways and touch points that connect people, networks, and other platforms together in the physical world. Translated into a digital system, the present invention allows for sharing and distributing products, services, and other forms of collaboration—in, out, and through—the distribution channels, while authenticating the source, movement, and delivery of the transactions through a distribution hash and crossed with the client-owner hash.

(D) Community Interactions is a multifaceted application which allows interactions to flow freely, within the internal organization and the external community, as interactions occur simultaneously between individuals, networks, and audiences. The present invention allows for a decentralized digital social community as it accounts for the source, storage, and circulation of digital community interactions. This digital system is engineered to expand and contract as multiple layers of interaction and information flow through the feedback loop. It tracks and balances the data circulation, allowing all forms of interaction to go where they are wanted and to unlimited locations. By providing decentralized ownership of digital applications, the present invention allows for all interactions—simultaneously, independently, and collaboratively—to go “in, out, and through” the loop as it functions seamlessly and free of chokepoints.

Referring to FIG. 5, illustrated is a method for connecting, communicating, collaborating, and distributing digital resources within and outside of independent devices, applications and interfaces through a decentralized digital community architecture. Whereas communication is a form of digital resource; whereas an event is a form of digital resource; whereas a user is a form of digital resource; whereas a client owns its own device and serves its own community, and whereas community interaction includes all forms of user-types.

Whereas user A in one device A communicates around event C that is shared within device A with another user B that communicates around the same event C that is shared within its device B that is owned by user C who created the event C from within its device C. All users/clients, A, B, and C illustrated in FIG. 5 can communicate from their respective devices around a shared digital resource without having to be displaced to the adjacent device, application, or interface to interact. Upon connection, User A and User B may continue to interact from separate devices.

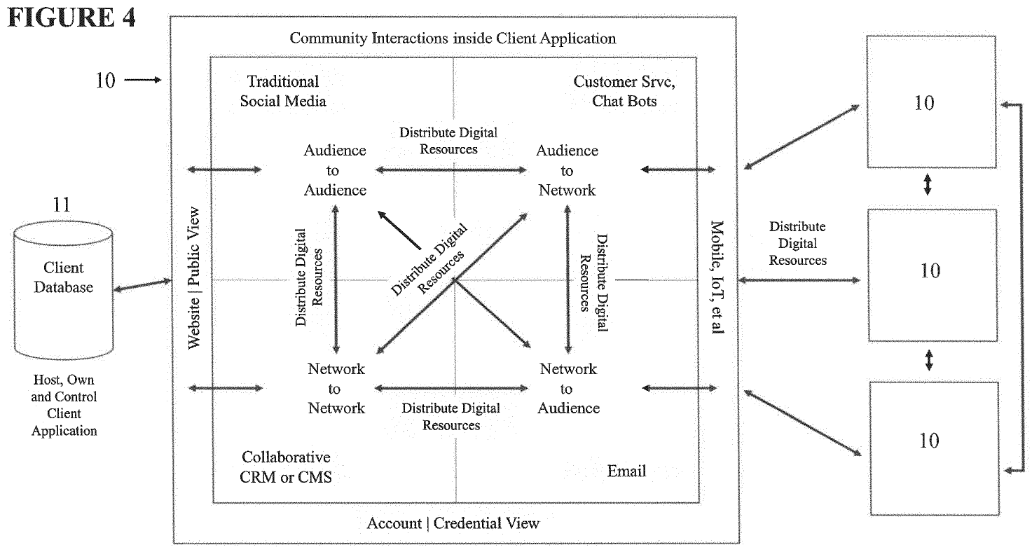

Referring to FIGS. 2 and 4., the present invention allows for digitally decentralized “communications” on at least the internet where individuals and groups of individuals and the internet of things can organize and interact with others around various interests and any digital resource. (d1 Audience to Audience). In another embodiment of the present invention, the architecture digitally allows interaction between the audience-user and the business network, representing the physical environment of “customer service” around any digital resource. (d2 Audience to Network). In yet another embodiment, the present invention digitally allows direct interaction between the business network and the audience-user, and involves the marketing campaigns of products, services, and events, or any digital resource (d3 Network to Audience). In yet another embodiment, the present invention allows collaboration between organizations, entities, and groups “to get the job done” in a physical environment. The present invention allows for collaborative interaction between networks, around a digital resource which can be distributed across any decentralized digital application, and allows the networks to interact, share data and any digital resource (d4 Network to Network).

Referring again to FIG. 2, (E) Algorithm Controls are specified and set by the client-owner. These filters, located in the digital central hub, identify the activities taking place in the physical environment, translating, and distributing them through the digital system according to the controls set by the client-owner, and adjusted based upon interactions and exchanges where the distributed algorithmic controls are made available to the community. The present invention allows the system to expand and contract as interactions, exchanges, and transactions are simultaneously taking place, independently or in collaboration with networks inside and outside the community. The receipt hash verifies the required information to authenticate and validate all interactions between users, which is done through a decentralized Hashmatch. Optionally, a digital community may embed a community Hashmatch for content verifications and indemnifications, and a group of communities can maintain a group community Hashmatch, all for identifying the specific communities or groups of communities from which content flows.

A (#) Hashmatch identifies patterns of inheritance at exchange points between users and orders the values into a unique combination sequence to verify source. Hashmatch may optionally include blockchain. Optionally, a Hashmatch may include patterns of inheritance at exchange points between users, a digital community or a digital group of communities to verify source Similar to how DNA contains a record of your ancestors as it relates to the source of you, so too does a Hashmatch contain a record of exchange as it relates to the source of a receipt. Each receipt hash inherits the traits of the users involved in the exchange, like when a male and female produce a child. DNA strands randomly match 50% of each contributing member gene in the offspring, while a Hashmatch specifically matches 100% of the user(s) involved and values associated in the exchange. The invention removes the randomness and allows for one or many users to produce a unique combination sequence in the receipt hash, which is then distributed into a ledger of each user involved in the exchange. Each position in the combination sequence is organized by any number of assigned hash values including exchange-type, exchange-role, exchange-amount, event-sequence, time, location, and user-type account numbers.

This process ensures every receipt hash is unique, verifiable, transparent, confirms the history of exchange, protects against fraud, and minimizes the demand of code storage requirements. Any change in the receipt hash triggers a hash value change that informs the users involved, who must verify the change is correct or not, to create a new receipt hash that references the previous Hashmatch. In a decentralized Hashmatch, the algorithms manage disputes based upon agreement of contributing users—even if the agreement is to disagree. The applications of a Hashmatch to any type of digital resource exchange. (for example: goods, services, communication, network, distributions, currency, etc.).

All modules and features work as a decentralized unit, or (F) Control Panel, which may be inserted into any digital environment of client-side source code developed for the client, then hosted, controlled, and owned by the client on their own server, and is available in the client designated repository. Simultaneously, the modules and features, located in the digital central hub, ensure connection, communication, and collaboration across all digital control points of interactions, distributions, and ownership of other clients in the community.

The (G) Database, located in the digital central hub, is designed specifically for the client-owner to ensure authentication of source and distribution data as activity passes “back and forth” through the distribution channels. Data is tied to a timestamp, verified interaction sign, distribution tag, and ownership hash. The present invention allows for the database to be owned, hosted, and controlled by the client-owner on their own server and designated repository.

The Backdrop Quadrant represents the environment in which the physical and digital worlds meet using at least the internet. The touch points and interactions are unlimited and far-reaching as they overlap, intersect, and interact in our daily lives.

Referring to FIG. 4, a1 Audience to Audience. The present invention allows for digitally decentralized “communications” where individuals and groups of individuals and the internet of things can organize and interact with others around various interests and any digital resource—where these shared interactions may happen in two discrete digital environments owned by two different client-owners with users sourced and/or distributed from two different locations; verified by the invention's decentralized Hashmatch.

Referring again to FIG. 4, a2 Audience to Network. The present invention digitally allows interaction between the user audience and the business network, representing the physical environment of “customer service” around any digital resource—where these interactions may happen in two different digital environments owned by two different client-owners with users sourced and/or distributed from two different locations with users sourced and/or distributed from another two different locations; verified by the invention's decentralized Hashmatch.

Referring again to FIG. 4, a3 Network to Audience. The present invention digitally allows direct interaction between the business network and the audience user, and involves the marketing campaigns of products, services, events, and any digital resource—where these interactions may happen in two different digital environments owned by two different client-owners with users sourced and/or distributed from two different locations; verified by the invention's decentralized Hashmatch.

Referring yet again to FIG. 4, a4 Network to Network. The present invention allows collaboration between organizations, entities, and groups “to get the job done” in a physical environment. The present invention further allows for collaborative interaction between networks, around a digital resource which can be distributed across any decentralized digital application and allows the networks to interact, share data, and any digital resource—where these interactions may happen in two different digital environments owned by two different client-owners with users sourced and/or distributed from two different locations; verified by the invention's decentralized Hashmatch.

Referring back to FIG. 6, Additional definitions include:
Digital Community (C) means the entire digital asset of a client in its own context.
Digital Infrastructure (I) means the management system to support the digital application.
Energy Value (eV) means any input captured, stored, contextualized, transmitted, uploaded, downloaded, distributed inside a digital community, including but not limited to networks, communications, campaigns, tools, statistics, data, finances, products, services, and any other form of digital content or resource;
Terminal (T) means a digital feature located inside a digital application where digital energy values move through/to/from the digital application, internally and externally to adjacent digital communities;
Modules (M) means a digital feature located inside the digital infrastructure (I) where digital energy values move through/to/from the digital infrastructure (I), internally and externally to adjacent digital communities (C); and
Alternate Community Matrix (ACm) means the mechanism by which digital energy values are generated, captured, stored, transmitted, contextualized, distributed, consumed, and used inside a digital community.

What is claimed is:

1. A method of creating a decentralized digital community within a network of social-networking users for managing and distributing content, the method comprising:
1. a decentralized digital community of users; one or more registered users within said digital community; a designated community standard for said users; said users capable of creating digital content within said user's data layer; a means of selectively sharing said user content within said digital community; said user content and user data layer within said digital community is at least owned, hosted, controlled and managed by said user for use, monetization and distribution; with aggregated said shared user content accessible within said digital community on a network connected to the internet.
2. The method according to claim 1, wherein a grouped decentralized digital community consists of two or more of said decentralized digital communities; the aggregated said shared user content hosted within said digital community on a network connected to the internet; said user content accessible within said grouped decentralized digital community.
3. The method according to claim 1, wherein said user grants the decentralized digital community the right to use and monetize user selected portions of said user content and user data layer.
4. The method according to claim 2, wherein said user grants said grouped digital community the right to use, monetize and distribute said user selected portions of user content and user data layer.
5. The method according to claim 1, wherein said use, monetization and distribution includes a right of at least one third-party application provider to access said content and said data layers for providing applications or services on a network; said right authorized by an entity selected from the group consisting of said user, said digital community, and said grouped digital community.
6. The method according to claim 2, wherein said use, monetization and distribution includes a right of at least one third-party application provider to access said content and said data layers for providing applications or services on a network; said right authorized by an entity selected from the group consisting of said user, said digital community, and said grouped digital community.
7. The method according to claim 3, wherein said use, monetization and distribution includes a right of at least one third-party application provider to access said content and said data layers for providing applications or services on a network; said right authorized by an entity selected from the group consisting of said user, said digital community, and said grouped digital community.
8. The method according to claim 1, wherein said content is identified with a verifiable content hashmatch for authentication purposes; and said content hashmatch is updated to track content sharing and content modification with said digital community.
9. The method according to claim 1, wherein said decentralized digital community is identified by a unique community hashmatch, said community hashmatch incorporated into said content hashmatch for identifying said digital content as emanating from said digital community.
10. The method according to claim 2, wherein each of said grouped decentralized digital community are identified by a grouped community hashmatch identifying said digital content as emanating from said decentralized digital community.
11. The method according to claim 2, wherein said decentralized digital community further comprises a central hub to filter all transactions and interactions through a series of algorithms, controls, and modules consistent with said designated community standard for said user collaboration.
12. A plethora of decentralized digitally connected communities comprising:
at least one decentralized digital community and infrastructure data layer consisting of a central hub to filter all transactions and interactions through the series of algorithms, and controls, consistent with said designated community standard for said user collaboration;
at least one community data layer in said decentralized digital community for content sharing, content modification and collaboration of user content within said decentralized communities;
said content sharing, content modification and collaboration, and all transactions and interactions therefrom, tracked within said digital decentralized communities by use of a hashmatch; and
at least one user data layer in said decentralized digital community wherein said user content is owned, hosted, controlled and managed by said user for use, monetization and distribution.
13. The method according to claim 12, wherein said decentralized digital community provides a means for sharing said content, content modification and collaboration between at least two or more digital decentralized communities.
14. The method according to claim 12, wherein said decentralized digital community provides a means for sharing said content, content modification and collaboration between at least two or more digital decentralized communities.
15. The method according to claim 12, wherein said content can be selectively removed, deleted or modified by said user across one or more decentralized digital community in which said user has authorized said content to be distributed.
